(19) United States
(12) Patent Application Publication
(10) Pub. No.: US 2019/0293411 A1
(43) Pub. Date: Sep. 26, 2019

(54) SYSTEM AND METHOD FOR RECORDING PROPERTIES OF AT LEAST ONE WHEEL OF A RAIL VEHICLE

(71) Applicant: AUE KASSEL GMBH, Kassel (DE)

(72) Inventor: Barbara NOWACZYK, Kaufungen (DE)

(21) Appl. No.: 16/331,207

(22) PCT Filed: Sep. 5, 2017
(86) PCT No.: PCT/EP2017/072269

§ 371 Date: Mar. 7, 2019

(30) Foreign Application Priority Data
Sep. 7, 2016 (DE) 10 2016 116 782.7

(51) Int. Cl. G01B 11/245; G01M 17/10; B61K 9/12; G06T 7/00; H04N 5/225; H04N 5/247; G06T 7/60; G06T 17/00

(52) U.S. Cl. CPC G01B 11/245; G01M 17/10; B61K 9/12; G06T 7/0002; G06T 2207/10052; H04N 5/247; G06T 7/60; G06T 17/00; G06T 2207/30252; H04N 5/22541

(57) ABSTRACT

A system for detecting properties of at least one wheel of a rail vehicle, where the system is arrangeable at at least one first rail, where the system has at least one first detection device, where the first detection device is configured to detect at least one first region of a wheel of a rail vehicle passing on the first rail; a system and a method for establishing properties of a wheel and/or a wheelset of a rail vehicle, in which the accuracy of the established properties of the wheel and/or of the wheelset is increased in comparison with systems and/or methods known from the prior art, is realized by virtue of the first detection device being a plenoptic camera.

The invention relates to a system and a method for detecting properties of a wheel and/or of a wheel set of a rail vehicle, in particular a geometric actual state of the wheel and/or wheelset.

The wheels of a rail vehicle are subject to wear or damage and abrasion as a result of the loads during operational use. In the process, the wear behavior of a wheel of a rail vehicle is influenced, for example, by the mileage, in particular depending on the route characteristic, the normal force per wheel and the driving and braking forces. In addition to continuous loads which lead to plastic deformation in the region of the tread, for example, individual events such as strong braking are also responsible for the wear. While the tread, in particular, is loaded in the case of railroads, the wheel flange, in particular, is affected by wear in the case of streetcars, for example, on account of the tight curve radii during driving operation.

The abrasion or deformation of the wheels of a rail vehicle is acceptable within predetermined limits and must therefore be controlled at regular intervals. Planning the maintenance of wheels and wheelsets of rail vehicles therefore has as a prerequisite knowledge of the actual wear behavior that is as accurate as possible in order to avoid unnecessary servicing or repairs but, at the same time, to identify damage and wear in timely fashion. To this end, each individual wheel is subject to regular checks, the intervals of which are often set on the basis of the mileage without, however, taking account of the actual loads.

In order to reduce the outlay for a regular detection of the current properties of a wheel, automatic systems that, e.g., optically detect the surface of a wheel have proven to be advantageous in practice. In this respect, the prior art has disclosed a multiplicity of different systems with varying precision.

By way of example, DE 10 2012 207 427 A1 discloses a method for checking a tread of a wheel of a train by optical scanning means. For detection purposes, the one camera is arranged in such a way that the tread of the wheel rolling along a rail is optically detected over the entire circumference thereof by adapting the depth of field of the camera and said tread is subsequently analyzed.

EP 1 992 167 B1 has disclosed a method for measuring properties of wheels of a rail vehicle, in which a reference marking is arranged in the track, said reference marking being identified in addition to the wheel to be detected by an image detection apparatus of the system.

However, the systems and methods known from the prior art are disadvantageous in that the detection of the surface of a wheel of a rail vehicle is not implemented with a sufficient accuracy.

The invention is therefore based on the object of specifying a system and a method for establishing properties of a wheel and/or a wheelset of a rail vehicle, in which the accuracy of the established properties of the wheel and/or of the wheelset is increased in comparison with systems and/or methods known from the prior art.

In a generic system, the object set forth at the outset is achieved by the features of the characterizing part of patent claim 1, specifically by virtue of the first detection device being a plenoptic camera. Plenoptic cameras are also referred to as light field cameras and are distinguished by virtue of the direction of the incident radiation also being detected in addition to the usually detected color and intensity of the radiation. The direction of the incident radiation is detectable using the first detection device.

By detecting the direction of the incident radiation, in particular the direction of the incident light, the detected image data also contain an information item about the image depth, and so there is the option of subsequent focusing, specifically of the plane of focus being subsequently adjustable in the detected region. As a result, a three-dimensional model of a detected object can be calculated on the basis of the image data of the plenoptic camera.

A three-dimensional model of the first region, in which a detection using the first detection device is implemented, can be calculated on the basis of the image data of the first detection device, which is embodied as a plenoptic camera. Actual dimensions of the wheel can be determined, and hence conclusions about the wear of the wheel can be drawn, on the basis of the geometric properties detected as image data.

The system is arranged on at least one first rail. In particular, the system comprises at least one first system part, which is arranged on at least one rail of a track. Preferably, provision is made of a second system part, which is arranged on a second rail of the track. The track comprises two rails extending substantially in parallel, wherein a passing rail vehicle is guided by the two wheels of a wheelset, with each on one of the rails. By way of example, the first system part is fastened to an assembly plate, which passes under the rail and is screwed to the rail base using two tensioning plates. A tensioning plate is arranged on each side of the rail, said tensioning plate interacting within the assembly plate by means of threads, in particular.

Here, whether the wheel is at rest or moved is of no importance to the functionality of the system; the system works in both cases. In particular, the system is embodied to detect the properties of a passing wheel within a speed range between 0.5 km/h and 100 km/h, in particular between 5 km/h and 15 km/h.

Preferably, the system comprises an evaluation unit, which is embodied as a computer system, for example. The evaluation unit is connected to the measurement unit by means of optical waveguides, for example. In particular, the evaluation unit comprises a database in which the detected data are storable and from which they are recallable. The evaluation unit is configured in such a way that it evaluates at least the first image data record of the first detection device of the first region. By way of example, the first image data record is therefore evaluated using the geometric arrangement of the detection devices relative to the rail and/or the wheel in order to obtain a very accurate model of the current surface of the wheel, in particular of the tread. From these data, the evaluation unit establishes material displacements in the region of the tread and further appearances of wear of the wheel, for example. Preferably, to this end, the currently established data are compared to known data from the database, for example to such data that were detected in respect of the same wheel at another—earlier—time.

Moreover, provision is preferably further made for the system to comprise at least one readout unit for a wheel transponder, e.g., for an RFID chip or a barcode, and/or a wheel load detection unit for measuring the wheel load of the wheel and/or a vibration monitoring unit for detecting vibrations of the wheel.

According to a first configuration, the accuracy of the image data detected by the first detection device can be increased by virtue of the plenoptic camera having at least one main lens and at least one structured film layer or a lens array between the main lens and at least one image sensor. By way of example, the structured film layer comprises a fine mesh of lines that allow conclusions to be drawn about the direction of the incident radiation. The lens grating leads to each picture element being refracted again and being guided onto the sensor surface of the image sensor in such a way that the direction of the incident radiation is determinable.

As an alternative thereto, provision according to a further configuration of the system is made for the plenoptic camera to comprise an image sensor comprising a plurality of detector layers arranged in succession, in particular wherein at least one detector layer is at least partly transparent. It is likewise possible to draw conclusions about the direction of the incident radiation by way of the successively arranged detector layers, which preferably consist of graphene.

According to further configuration of the system, the precision with which the properties of at least one wheel of a rail vehicle are detected is increased by virtue of at least one second detection device, in particular a second plenoptic camera, being present and by virtue of the second detection device being configured to at least partly detect a second region on the wheel, preferably by virtue of at least one third detection device, in particular a third plenoptic camera, being present, and by virtue of the third detection device being configured to at least partly detect a third region on the wheel.

The second and/or the third detection device respectively detect, at least in part, a second and third region on the wheel arranged on the rail, i.e., standing on the rail or passing over the rail. The accuracy of the established geometric data of the wheel is increased by detecting further regions as more image data are present, specifically from the first region and/or the second region and/or the third region.

Preferably, the first region and/or the second region each comprise part of the tread and part of the wheel flange. Preferably, the third region is directed to the wheel back and additionally comprises part of the wheel flange. Preferably, the system comprises three detection devices, specifically a first detection device directed to the first region, a second detection device directed to the second region and a third detection device directed to the third region.

Moreover, the detection accuracy is increased by a further configuration of the system by virtue of at least one first radiation source for emitting radiation in a certain wavelength range being comprised and by virtue of at least one detection device, i.e., the first detection device and/or the second detection device and/or the third detection device, being embodied to detect the radiation in the wavelength range of the first radiation source.

By way of example, the first radiation source illuminates, at least in part, the first region and/or the second region and/or the third region on the wheel arranged on the rail. Preferably, the first radiation source is directed to the first region.

By way of example, the first radiation source is embodied as an infrared radiation source. If the first radiation source is embodied as an infrared radiation source, the detection device or devices is/are also embodied in such a way that radiation is detectable in the wavelength range of the infrared radiation of the radiation source. Preferably, a second radiation source is provided for the second region and a third radiation source is provided for the third region. A radiation source irradiates the respective region at least in part, preferably in full. In particular, the first radiation source and/or the second radiation source and/or the third radiation source is embodied as a laser, in particular as an infrared laser. Consequently, the radiation sources emit radiation in a spectral range between 1 mm and 780 nm, or in a frequency range from 300 GHz to 400 THz. Then, the detection devices are accordingly embodied in such a way that these are able to detect infrared radiation reflected by the wheel and able to convert this into image data records.

According to a further configuration, the functionality of the system is increased by virtue of at least one braking detection device being present and by virtue of the braking detection device being embodied as a plenoptic camera. Preferably, the system comprises two, in particular three braking detection devices, i.e., a number corresponding to the number of brake disks provided on a wheelset. The braking detection device, in particular the plenoptic camera, is arranged on the rail and aligned in such a way that at least one brake disk of a wheel or wheelset passing along the rail is detectable by means of the braking detection devices, at least at a trigger time. The dimensions of the brake disk can be determined, and the wear can be deduced on the basis of the detected image data of the geometric properties.

According to a further configuration, the control of the system is improved by virtue of provision being made for at least one trigger device to be present, for the trigger device to be directed to the wheel arranged on the rail and for a detection with at least one detection device to be triggerable by the trigger device. The detection device preferably detects the presence of the at least one wheel arranged on the rail and triggers the detection by at least one detection unit at a predetermined trigger time. Preferably, the trigger device triggers the detection by the first detection unit and/or second detection unit and/or third detection unit at a trigger time. In particular, the trigger device also triggers an emission of radiation by the first radiation source and/or the second radiation source and/or the third radiation source, at least the trigger time, such that the first region and/or the second region and/or the third region are illuminated at the trigger time.

By way of example, the system has a second trigger device, wherein the second trigger device is likewise directed to the wheel arranged on the rail and in that a detection by at least one detection unit is triggerable by means of the first trigger device and the second trigger device. Preferably, the detection by at least the first detection unit and/or the second detection unit and/or the third detection unit is triggered at a trigger time by means of the two trigger devices. In particular, the trigger devices also trigger an emission of radiation by the first radiation source and/or the second radiation source and/or the third radiation source at the trigger time such that the first region and/or the second region and/or the third region are illuminated at the trigger time.

Advantageously, provision is made for the first trigger device and the second trigger device to be spaced apart from one another in the rail longitudinal direction. Preferably, one trigger device detects a part of the circumference of the wheel facing the movement direction and the second trigger device detects part of the circumference of the wheel facing away from the movement direction.

According to a last configuration, the system can be improved by virtue of a second system part being comprised, by virtue of the second system part having an identical embodiment to the first system part and by virtue of the second system part being arranged on the second rail of the track. Preferably, the second system part is embodied and configured in such a way that a second wheel of a rail vehicle, preferably the second wheel assigned to the wheelset of the first wheel, is detectable.

Consequently, a first system part and a second system part allow simultaneous detection of the first wheel and the second wheel of a wheelset and determination of the properties. Preferably, properties of the first wheel and of the second wheel are detected at the same time as a trigger time by the first system part and the second system part. Moreover, statements in respect of the position of the first wheel and of the second wheel relative to one another can be made by way of the software-controlled evaluations since the assembly positions and alignment of the detection devices of the first system part and of the second system part are fully known, even relative to one another. To this end, provision is made for the alignment and assembly positions of all detection devices and/or radiation sources, in particular also relative to one another, to be taken into account during the evaluation by the evaluation unit in order to establish properties of the wheelset.

The object set forth at the outset is further achieved by a method for ascertaining properties of a wheel, of a rail vehicle, characterized by the following steps:
detecting a first region of a wheel arranged on a rail using at least one first detection device that is embodied as a plenoptic camera and producing at least one first image data record.

Consequently, the wheel arranged on a rail, i.e., the wheel standing on or passing along the rail, is detected by the first detection device and an image data record is generated. Any desired geometric properties, i.e., dimensions of the wheel, are determined on the basis of this image data record and the servicing intervals or necessary servicing of the wheel is set thus.

A first configuration of the method provides for an additional method step to be comprised, specifically calculating a model data record using the first image data record, wherein the model data record is representable as a three-dimensional, at least partial model of the first wheel. The model data record is calculated from the image data record by virtue of the data being converted into a three-dimensional, at least partial model of the wheel. Then, the converted data can be used to establish the geometric properties of the wheel.

Further, the method is advantageously embodied by virtue of a projection of radiation into the at least first region being implemented using at least one first radiation source, at least at the trigger time, i.e., the time at which a detection is carried out by at least the first detection unit. This is advantageous in that at least the first region is illuminated by the radiation source at the detection time, as a result of which the quality of the image data detected by the detection unit is increased.

In particular, this is advantageous if the projection is implemented in the nonvisible infrared range, i.e., in the infrared range that is not visible to the human eye. Preferably, the detection is implemented simultaneously by a first detection unit, a second detection unit and a third detection unit, wherein, at the trigger time, there is also a projection with a first radiation source, a second radiation source into the second region and a third radiation source into the third region.

Advantageously, the method is developed by virtue of the profile data record being calculated from the model data record and by virtue of the profile data record being compared to at least one further profile data record that is stored in a database and by virtue of changes in the geometric properties of the wheel being established on the basis of this comparison. The profile data record represents all image data—to the extent these are present—of the first detection device and/or the second detection device and/or the third detection device.

Furthermore, the use of a plenoptic camera for detecting properties of a wheel of a rail vehicle on a rail is claimed according to the invention.

In detail, there now are a multiplicity of options for designing and developing the system and the method. In this respect, reference is made to the patent claims following patent claims 1 and 9 and to the following description of preferred exemplary embodiments in conjunction with the drawing. In the drawing:

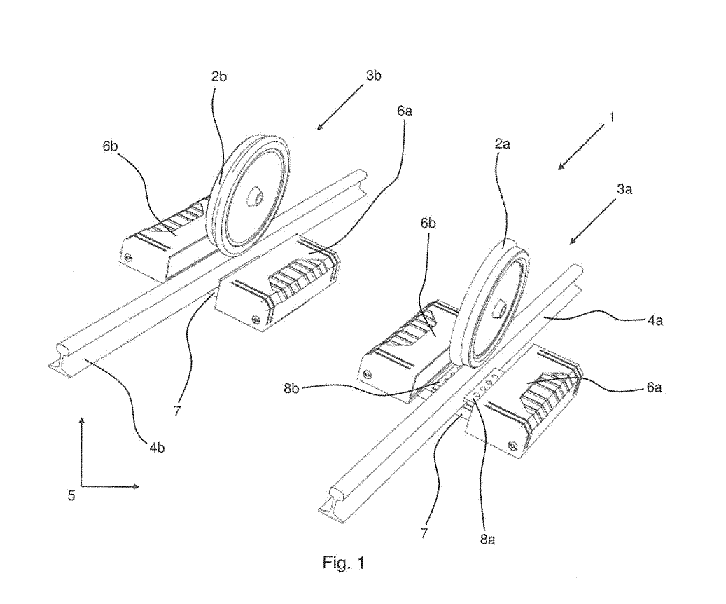

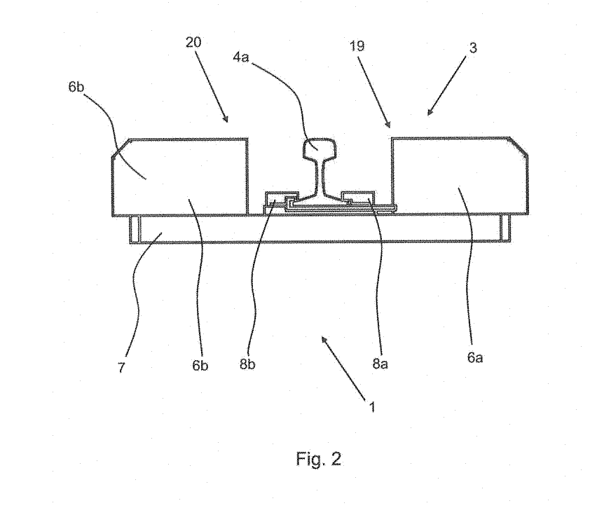

FIG. 1 shows an exemplary embodiment of a system in a perspective view, FIG. 2 shows an exemplary embodiment of a system in a sectional view,

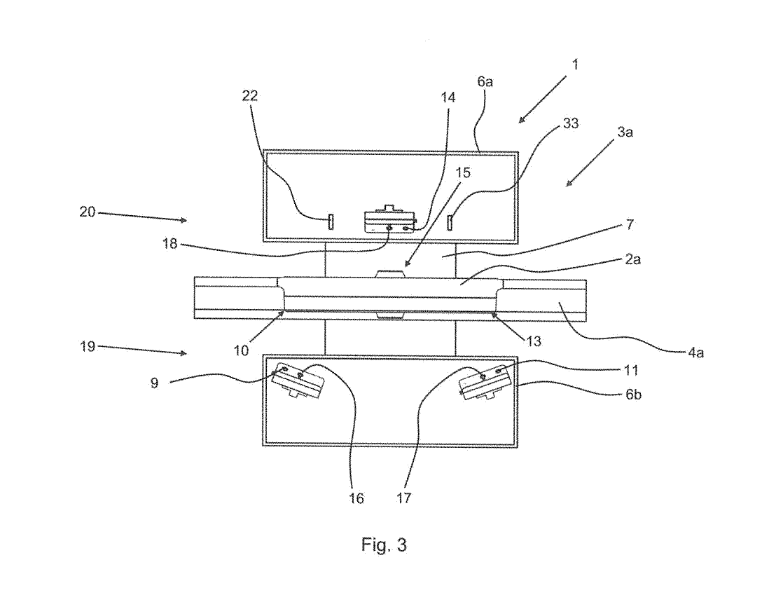

FIG. 3 shows an exemplary embodiment of a system in a plan view,

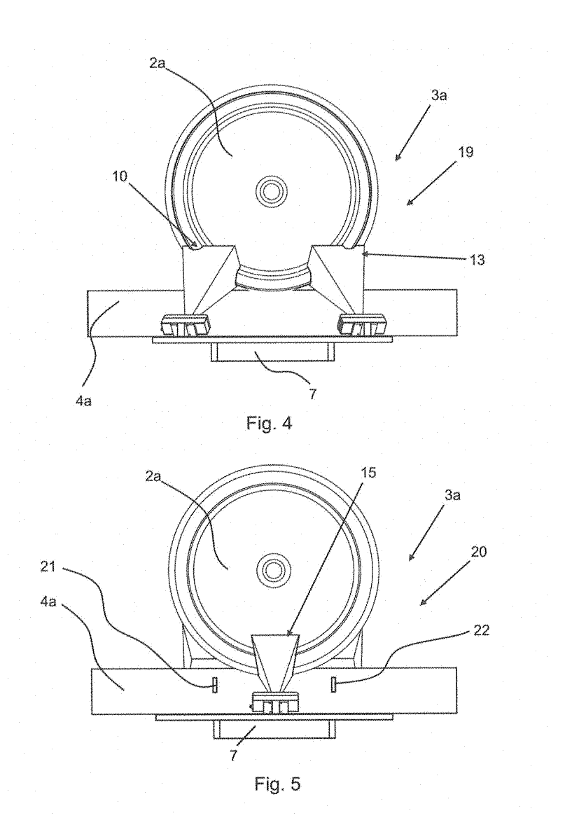

FIG. 4 shows an exemplary embodiment of a system in a side view,

FIG. 5 shows an exemplary embodiment of a system in a side view,

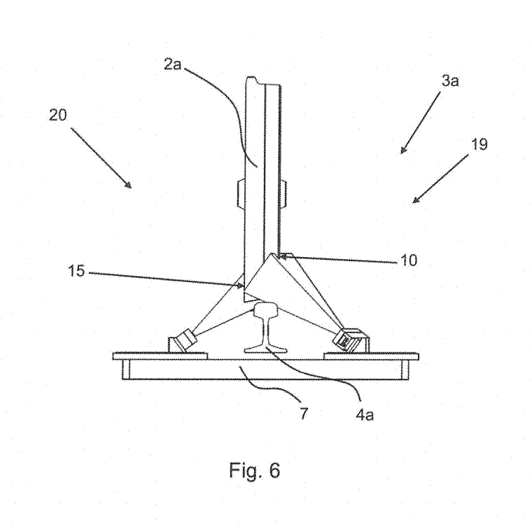

FIG. 6 shows an exemplary embodiment of a system in a view from the front,

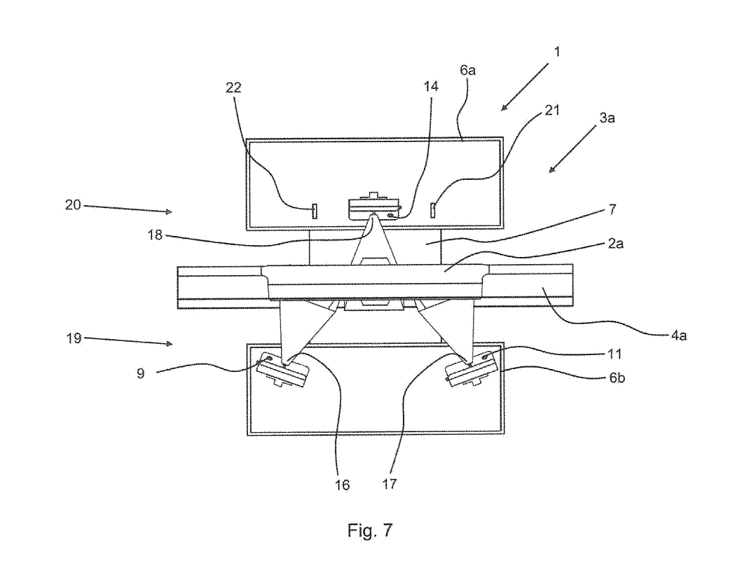

FIG. 7 shows an exemplary embodiment of a system in a plan view,

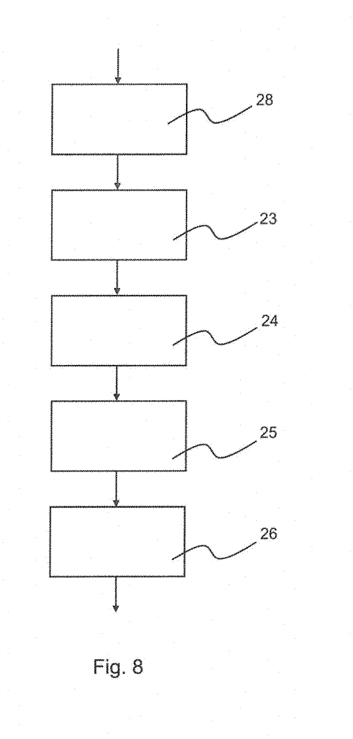

FIG. 8 shows an exemplary embodiment of a schematic procedure of a method,

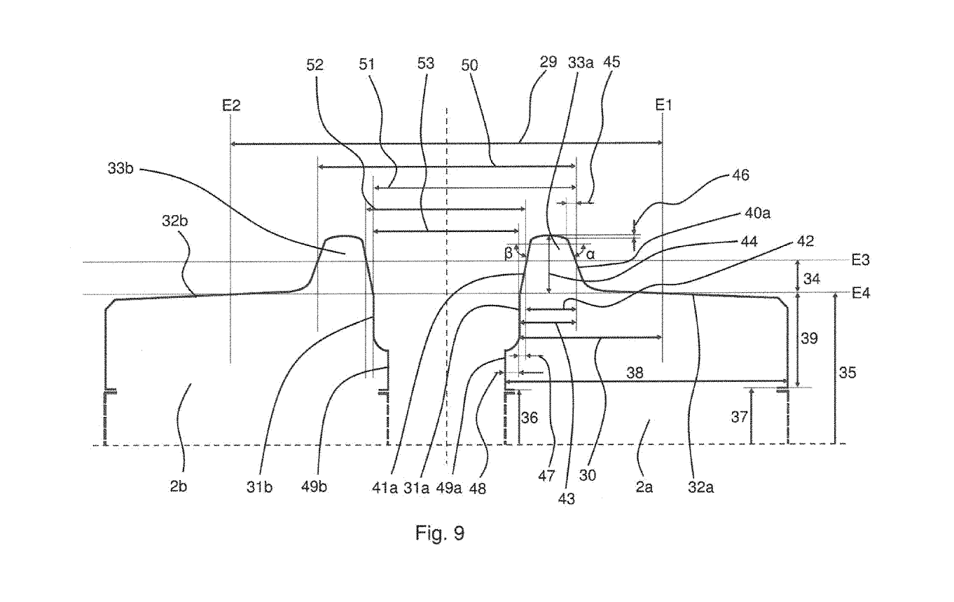

FIG. 9 shows an exemplary overview of an overview of the geometric properties of the wheel,

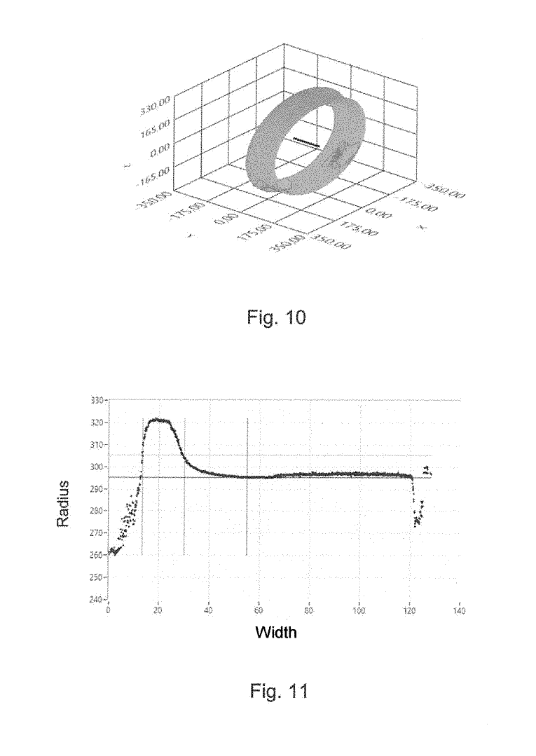

FIG. 10 shows an exemplary three-dimensional representation of a model data record, and

FIG. 11 shows an exemplary two-dimensional representation of a profile data record.

FIG. 1 shows a system 1 for detecting properties of at least one wheel 2a, 2b of a rail vehicle—not illustrated. The system 1 comprises a first system part 3a and a second system part 3b, which have completely identical embodiments. The first system part 3a serves to detect properties of a first wheel 2a and the second system part 3b serves to detect the properties of a second wheel 2b of a wheelset. The first system part 3a and the second system part 3b are identical, which is why reference is only made to the first system part 3a below.

FIG. 1 shows that the first system part 3a comprises a first outer housing 6a and a second outer housing 6b. The system 1 is arranged on a track 5 comprising a first rail 4a and a second rail 4b. The first outer housing 6a and the second outer housing 6b are arranged on an assembly plate 7, which passes under the rail 4a and which is fastened to the rail base of the rail 4a by means of tensioning plates 8a, 8b. The first outer housing 6a and the second outer housing 6b are designed in such a way that the upper edge lies level with the rail upper edge or therebelow.

FIG. 2 shows the system part 3a in a side view with a cut first rail 4a. The assembly plate 7 passes below the rail 4a and is fastened to the rail base of the rail 4a by means of tensioning plates 8a, 8b. The outer housings 6a and 6b of the system 1 are fastened to the assembly plate 7 and, with their upper edge, are situated level with the upper edge of the rail 4a.

FIG. 3 shows a plan view of an exemplary embodiment of a system 1, in particular of a first system part 3a. The first system part 3a comprises at least one first detection device 9, which is directed to a first region 10 of the wheel 2a arranged on the rail 4a and which detects said first region, in particular at at least one trigger time. Further, the first system part 3a has a second detection device 11 for a second region 13 and a third detection device 14 for a third region 15. In addition to the detection devices 9, 11, 14, the first system part 3a has a first radiation source 16 for emitting radiation into the first region 10, a second radiation source 17 for emitting radiation into the second region 13 and a third radiation source 18 for emitting radiation into the third region 15. The first detection device 9, the second detection device 11 and the third detection device 14 are each embodied as a plenoptic camera, i.e., as a light field camera. In addition to the intensity, the plenoptic cameras also detect the direction of the incident radiation, as a result of which an at least partial three-dimensional image of the wheel 2a is producible.

The exemplary embodiment according to FIG. 3 can be gathered from FIGS. 4 to 7, wherein the electromagnetic radiation projected by the first radiation source 16, the second radiation source 17 and the third radiation source 18, in particular expanded laser beams, are illustrated in exemplary fashion.

What can be gathered from FIG. 3, FIG. 6 and FIG. 7 is that the first detection unit 9 and the second detection unit 11 are arranged on a first side 19 of the rail 4a while the third detection device 14 is arranged on a second side 20 of the rail 4a. A first trigger device 21 and a second trigger device 22 are arranged on the second side 20 of the rail 4a, said trigger devices setting the trigger time for the radiation sources 16, 17, 18 and the detection devices 9, 11, 14 according to set criteria such that an emission or projection and detection is implemented in all three regions 10, 13, 15 at the same time.

FIG. 8 shows a schematic procedure of an exemplary embodiment of a method for detecting properties of a wheel 2a of a rail vehicle, comprising the following method steps:
projecting 28 radiation into at least the first region 10 using at least one first radiation source,
detecting 23 at least a first region 10 of a wheel 2a arranged on a rail using at least one first detection device 9 that is embodied as a plenoptic camera and producing 24 at least one first image data record,
calculating 25 a model data record using the first image data record, wherein the model data record is representable as a three-dimensional, at least partial model of the first wheel 2a,
calculating 26 a profile data record using the model data record, wherein the profile data record is calculated by transforming the model data record into a plane and wherein the profile data record is representable as an at least partial, two-dimensional profile of the first wheel 2a.

The image data record contains those geometric properties of the wheel 2a in the first region 10 that can be evaluated. Preferably, this is implemented in a development of the method, specifically by virtue of calculating 25 a model data record (see FIG. 10) using the first image data record, wherein the model data record is representable as a three-dimensional, at least partial model of the first wheel 2a.

Preferably, a profile data record is subsequently calculated 26 from the model data record. The profile data record serves as a basis for determining the geometric properties of the wheel 2a, for example the height and width of the wheel flange, the profile of the tread, etc. An exemplary three-dimensional representation of the wheel 2a, specifically a model data record, can be gathered from FIG. 10; an exemplary two-dimensional representation of the profile of the wheel 2a in the region of the tread and the wheel flange, specifically the profile data record, can be gathered from FIG. 11.

FIG. 9 shows an overview of the establishable geometric properties of the first wheel 2a and of the second wheel 2b and of the properties of the first wheel 2a relative to the second wheel 2b, i.e., of the wheelset. The system 1, in particular an evaluation unit, and/or the method are, in particular, embodied and configured in such a way that all dimensions illustrated in FIG. 9 are establishable and/or established, either individually or in combination. Consequently, the system 1 and/or the method are configured to establish all dimensions illustrated in FIG. 9, either individually or in combination. In particular, the dimensions illustrated in FIG. 9 are established from the profile data record and/or the correlation of the profile data record of the first wheel 2a with the profile data record of the second wheel 2b and the arrangement of detection units 9, 11, 14.

The measuring circle plane distance 29 specifies the distance between the measuring circle plane E1 of the first wheel 2a and the measuring circle plane E2 of the second wheel 2b. The measuring circle plane E1 and the measuring circle plane E2 are arranged in such a way that the axis of rotation of the first wheel 2a and the axis of rotation of the second wheel 2b pass through the measuring circle plane E1 and the measuring circle plane E2 in substantially orthogonal fashion. Further, the measuring circle plane E1 and the measuring circle plane E2 are arranged in such a way that they are spaced apart from the inner flank 31a of the first wheel 2a or the inner flank 31b of the second wheel 2b with the measuring circle plane distance-x 30 of between approximately 60 mm and 65 mm. The intersecting circle of the measuring circle plane E1, E2 and the tread 32a, 32b defines the contact ring or contact point of the wheel 2a, 2b.

The dimensions on the wheel flange 33a, 33b are determined in a sectional plane E3, which is arranged orthogonal to the measuring circle plane E1, E2 and which, in the illustrated cross section, is spaced apart from the point of intersection of the measuring circle plane E1, E2 with the tread 32a, 32b with a measuring circle plane distance-y 34 of approximately 10 mm.

The diameter 35 of the wheel 2a is likewise determined in the measuring circle plane E1. Further important dimensions of the wheel are the wheel body inner diameter 36 and the wheel body outer diameter 37, as well as the wheel tire width 38. The height 39 of the wheel tire is determined in the measuring circle plane E1 between the lower edge of the wheel tire and the point of intersection with the tread 32a.

The sectional plane E3 forms the basis for the dimensions of the wheel 2a in the region of the wheel flange 33a. The points of intersection—in the illustrated cross section—of the sectional plane E3 with the inner flank 40a of the wheel flange 33b and the outer flank 41a of the wheel flange 33a form the starting point for the subsequent dimensions. A first wheel flange width 42 is determined as the distance between the points of intersection of the wheel flange 33a in the sectional plane E3. A second wheel flange width 43 is determined between the inner point of intersection of the wheel flange 33a with the sectional plane E3 and the inner flank 31a. A wheel flange height 44 is determined from a plane E4, in which the point of intersection of the measuring circle plane E1 with the tread 32a lies, to the upper edge of the wheel flange 33. The inclination of the inner flank 40a and of the outer flank 41a are described by the angles α and β. Alternatively, the inclination of the inner flank 40a can be specified by the distance 45 emerging from the inner point of intersection of the sectional plane E3 with the wheel flange 33a at its inner flank 40a and the point of intersection of the inner flank 40a at a distance 46 of between 0.9 mm and 2 mm from the upper edge of the wheel flange 33a. The flank dimension 47 specifies the distance between the outer point of intersection of the sectional plane E3 with the outer flank 41a of the wheel flange 33a and the inner flank 31a. The flank dimension 48 specifies the distance between the guide flank 49a and the inner flank 31a.

The system 1 and/or the method are embodied and configured, in particular, in such a way that the dimensions illustrated in FIG. 9 are also establishable and/or established as geometric properties of the first wheel 2a relative to the second wheel 2b, in particular by correlating the profile data record of the first wheel 2a with a profile data record of the second wheel and the geometric arrangement of the detection units 9, 11, 14.

As a result of the arrangement of the detection units 9, 11, 14 of the first system part 3a and of the second system part 3b relative to one another being known in a system 1, these information items are evaluable by the evaluation unit for appropriate evaluation purposes and are used for calculation purposes.

The measuring circle plane distance 29—as already explained—specifies the distance between the measuring circle plane E1 of the first wheel 2a and the measuring circle plane E2 of the second wheel 2b. The gage dimension 50 specifies the distance between the points of intersection of the inner flanks 40a, 40b with the sectional plane E3. The guide dimension 51 can be determined on both sides and defines the distance of the point of intersection of the sectional plane E3 with the inner flank 40a of the first wheel 2a and the inner flank 31b of the second wheel 2b. The guide circle distance 52 defines the distance of the point of intersections of the sectional plane E3 with the outer flanks 41a and 41b. The back-to-back distance 53 defines distance between the inner flanks 31a and 31b of the first wheel 2a and of the second wheel 2b.

FIG. 10 shows, in exemplary fashion, the illustrated data of the model data record, specifically an at least partial model of the wheel 2. The regions illustrated in framed fashion are actually supported by data, i.e., data calculated from the image data records. The dimensions along the axes x, y, z are specified in millimeters. The model data record comprises a multiplicity of measurement data points in a three-dimensional coordinate system, preferably as polar coordinates. The measurement data points image these as surface of the wheel 2 in the detected regions 10, 13, 15.

FIG. 11 shows, in exemplary fashion, the illustrated data of a profile data record, specifically a two-dimensional profile of the wheel 2 in the region of the tread 32 (see FIG. 9) and of the wheel flange 33. The wheel width is illustrated along the x-axis and the radius of the wheel 2a is plotted on the y-axis, respectively in millimeters. In FIG. 11, all measurement data points of the model data record from FIG. 10 have been transformed into a two-dimensional Cartesian coordinate system such that an average profile of the wheel 2 according to FIG. 11 arises in the region of the tread 32, the wheel flange 33 and the inner flank 31. Further, the data contain the diameter 35 of the wheel 2a.

1. A system for detecting properties of at least one wheel of a rail vehicle, wherein the system is arrangeable at at least one first rail, wherein the system has at least one first detection device, wherein the first detection device is configured to detect at least one first region of a wheel of a rail vehicle passing on the first rail, wherein the first detection device is a plenoptic camera.

2. The system as claimed in claim 1, wherein the plenoptic camera has at least one main lens and at least one structured film layer or a lens raster between the main lens and at least one image sensor.

3. The system as claimed in claim 1, wherein the plenoptic camera has an image sensor comprising a plurality of detector layers arranged in succession, in particular wherein at least one detector layer is at least partly transparent.

4. The system as claimed in claim 1, wherein at least a second detection device, in particular a second plenoptic camera, is present and wherein the second detection device is configured to at least partly detect a second region on the wheel, preferably wherein at least a third detection device, in particular a third plenoptic camera, is present, and wherein the third detection device is configured to at least partly detect a third region on the wheel.

5. The system as claimed in claim 1, wherein at least one first radiation source for emitting radiation in a certain wavelength range is comprised and wherein at least one detection device is embodied to detect the radiation in the wavelength range of the first radiation source.

6. The system as claimed in claim 1, wherein the system is configured to simultaneously implement detecting with the first detection device and/or the second detection device and/or the third detection device.

7. The system as claimed in claim 1, wherein at least one brake detection device is present and wherein the brake detection device is embodied as a plenoptic camera.

8. The system as claimed in claim 1 wherein at least one trigger device is present, wherein the trigger device is directed to the wheel arranged on the rail and wherein a detection with at least one detection device is triggerable by the trigger device.

9. A method for establishing properties of a wheel of a rail vehicle, in particular using a system as claimed in claim 1, further comprising:
detecting at least a first region of a wheel arranged on a rail using at least one detection device that is embodied as a plenoptic camera and producing at least one first image data record.

10. The method as claimed in claim 9, further comprising:
calculating a model data record using the first image data record, wherein the model data record is representable as a three-dimensional, at least partial model of the first wheel.

11. The method as claimed in claim 10, further comprising:
calculating a profile data record using the model data record, wherein the profile data record is calculated by transforming the model data record into a plane and wherein the profile data record is representable as an at least partial, two-dimensional profile of the first wheel.

12. The method as claimed in claim 11, further comprising:
comparing the profile data record to at least one further profile data record that is stored in a database, wherein changes in the geometric properties of the wheel are detected on the basis of this comparison.

13. The method as claimed in claim 9, further comprising:
projecting radiation into at least the first region using at least one first radiation source.

14. The system as claimed in claim 1 wherein the plenoptic camera is configured for detecting properties of a wheel of a rail vehicle standing on, or moving along, a rail.
